(19) United States
(12) Patent Application Publication
(10) Pub. No.: US 2021/0389051 A1
(43) Pub. Date: Dec. 16, 2021

(54) HIGH-PERFORMANCE, ENERGY-SAVING, AUTOMATIC COOPER-MELTING APPARATUS

(71) Applicant: Jiangxi Xinborui Technology Co., Ltd., Yingtan City (CN)

(72) Inventors: Xiaodong Chen, Yingtan City (CN); Zeren Chen, Yingtan City (CN); Guohe Huang, Yingtan City (CN)

(21) Appl. No.: 17/344,978

(22) Filed: Jun. 11, 2021

(30) Foreign Application Priority Data
Jun. 16, 2020 (CN) 202010549190.8

(51) Int. Cl. F27B 15/10; B01F 3/04

(52) U.S. Cl. CPC F27B 15/10; C01G 3/10; B01F 3/04539

(57) ABSTRACT

A high-performance, energy-saving, automatic cooper-melting apparatus, includes peripherals containing a tank acting as a main body. The tank has a top capped by an upper stirring device that has a top equipped with a lid. The lid has a lower surface with a sealing pad attached thereto. The sealing pad is centrally installed with a stirring motor. The stirring motor is centrally installed with a post. The post is equipped peripherally with stirring rollers. The tank contains a probe connected to an electric cord whose two ends are connected to an air suspension blower and a DCS detecting device, respectively. The tank contains a screen plate. The tank has one lateral provided with an air pipe and an opposite lateral provided with a liquid pipe. The air pipe has one end fixed with an air pipe stirrer, and the liquid pipe has one end fixed with a liquid pipe stirrer.

### BACKGROUND OF THE INVENTION

### 1. Technical Field

The present invention relates to preparation of cupric sulfate, and more particularly to a high-performance, energy-saving, automatic cooper-melting apparatus.

### 2. Description of Related Art

The process of making CuSO₄ from copper wire or electrolytic copper blocks with the presence of sulfuric acid necessitates air, water, copper mass, and temperature and can be expressed by the reaction formula below:

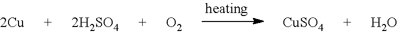

In this process, air acts as the source of oxygen and is therefore of high importance. Copper first reacts with oxygen and undergoes oxidation. The resulting CuO then reacts with sulfuric acid to generate CuSO₄. The faster copper gets oxidized, the faster CuSO₄ is generated. Oxygen is supplied through the air pipe and the liquid pipe equipped at the bottom of the copper melting tank. The more plentiful and even O₂ is in the supplied liquid, the faster copper melts. Gas-liquid opposite ejection allows oxygen to be well mixed with the solution, and vents densely and evenly formed on the screen plate further facilitate oxygen in the air being mixed into the solution. Then when the solution flows upward, full contact happens at the interface between oxygen and copper, so that the surface of copper is adequately oxidized, thereby achieving simple and efficient copper melting.

However, the prior-art devices for making copper salts are diverse, and tend to suffer from uneven air supply, poor copper-melting efficiency, high energy consumption, high data delay, high process variation, and low automation, thus being unfavorable to consistent, efficient and energy-saving production.

Hence, the present invention discloses a high-performance, energy-saving, automatic cooper-melting apparatus that addresses the foregoing problems.

### SUMMARY OF THE INVENTION

The objective of the present invention is to provide a high-performance, energy-saving, automatic cooper-melting apparatus that addresses problems as described previously.

To achieve the foregoing objective, the present invention employs the following technical schemes: a high-performance, energy-saving, automatic cooper-melting apparatus comprising peripherals, which include a tank acting as a main body, the tank having a bottom peripherally installed with a foundation whose bottom is provided with supports, the tank having a top capped by an upper stirring device, the upper stirring device having a top being equipped with a lid, the lid having a lower surface with a sealing pad attached thereto, the sealing pad being centrally installed with a stirring motor, the stirring motor being centrally installed with a post, the post being equipped peripherally with stirring rollers, the tank having an upper part containing a probe, the probe having one end fixed with an electric cord, the electric cord having one end connected to an air suspension blower, the electric cord having an opposite end connected to a DCS detecting device, the tank having a middle part containing therein a screen plate, the tank having one lateral provided with an air pipe, the tank having an opposite lateral provided with a liquid pipe, the air pipe having one end fixed with an air pipe stirrer, the liquid pipe having one end fixed with a liquid pipe stirrer, and the air pipe stirrer and the liquid pipe stirrer being contained in the tank and near the bottom of the tank.

As a preferred embodiment, the liquid pipe has an opposite end connected to a flushing pump, and the tank contains therein a discharging pump near the top of the tank, while the tank is provided at the bottom a feeding pump.

As a preferred embodiment, the liquid pipe stirrer has an inlet installed with a 304 stainless-steel section, the 304 stainless-steel section having one end provided with an adaptor, the adaptor having an end opposite to the 304 stainless-steel section connected to a 316L tube, the 316L tube having one end provided with a bearing, the bearing being sealed in a spherical drum by a sealing pad, the spherical drum having a bottom peripherally installed with a plurality of stirring rods, the stirring rods being connected distally by a ring, the stirring rods and the ring each being provided at a surface thereof with a plurality of holes, the spherical drum having one end opposite to the adaptor provided with a coupling by means of welding, and the coupling having one end opposite to the spherical drum installed with a mixing motor.

As a preferred embodiment, the 304 stainless-steel section has an outer surface covered by a sponge insulation layer, and the screen plate is formed with dense and evenly arranged meshes, each having a diameter of 1 mm.

As a preferred embodiment, the air pipe and the liquid pipe are provided with identical stirrers, or, the air pipe stirrer and the liquid pipe stirrer are structurally and dimensionally the same, and the air pipe stirrer and the liquid pipe stirrer are separated from each other by an impacting interval of 10 cm.

The present invention provides the following beneficial effects over the prior art.

The disclosed apparatus implements gas-liquid opposite ejection to enable even distribution of oxygen and features a simple structure and high performance as evidenced by its 400 kg/h copper-melting capacity. The disclosed apparatus leverages the 90° C.-120° C. hot air generated by the 20000 rpm rotation of the air suspension blower to heat the solution, thereby eliminating the need for an additional electric or steam boiler and in turn saving an equipment investment equal to about USD 70,000 and a power bill of USD 2,600 per day. In addition, the disclosed apparatus replaces manual adjustment with automation, thereby achieving consistent production and smart-factory practice.

### BRIEF DESCRIPTION OF THE DRAWINGS

FIG. 1 is a cross-sectional view of the present invention;

FIG. 2 is a simplified perspective view of the present invention; and

FIG. 3 is a perspective view of a stirrer used in the present invention.

### DETAILED DESCRIPTION OF THE PREFERRED EMBODIMENTS

The following description is to be read in conjunction with the accompany drawings to illustrate the technical schemes of embodiments of the present invention in detail. It is apparent that the described embodiments are merely exemplary, but not exhaustive. All other embodiments obtained by people of ordinary in the art based on embodiments of the present invention without creative efforts are within the scope of the present invention.

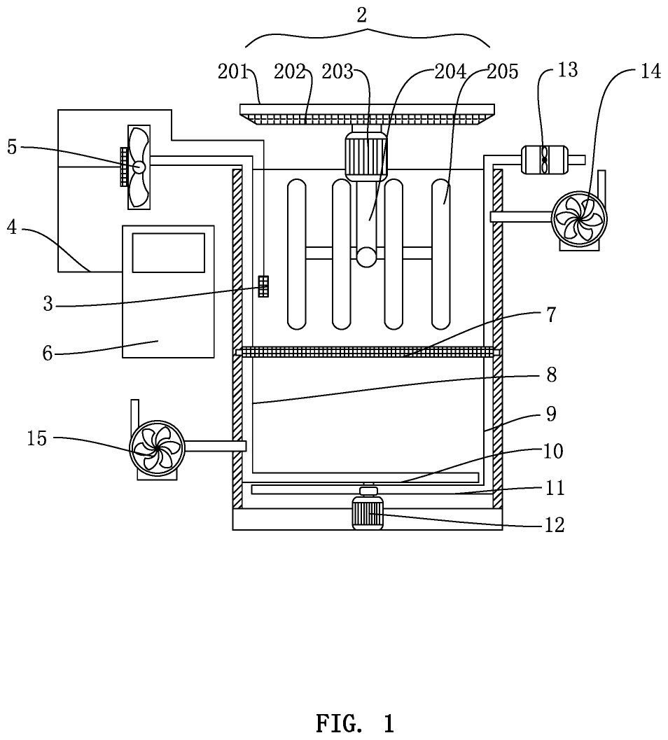

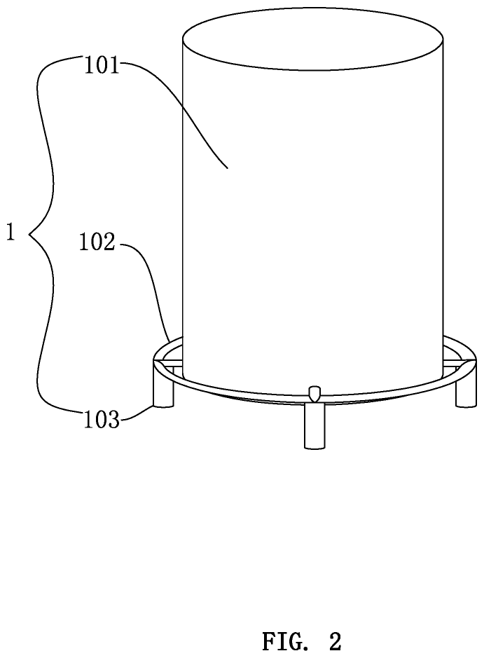

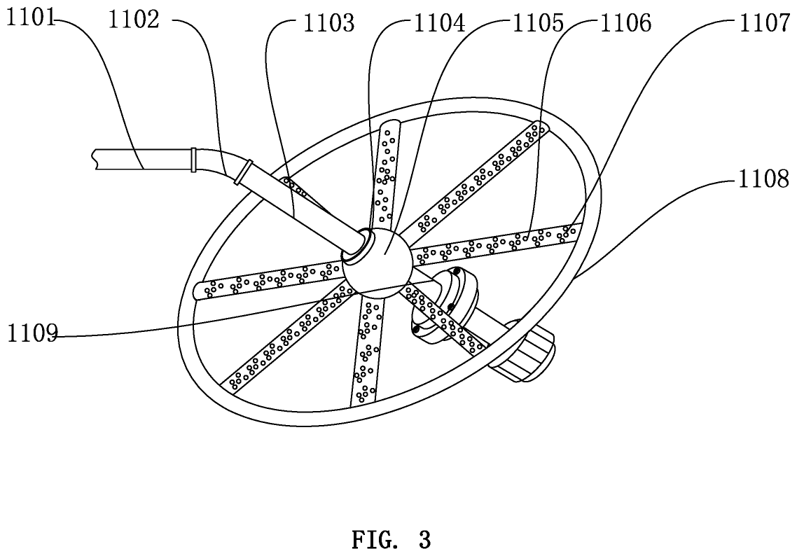

Referring to FIG. 1-3, the present invention provides technical schemes as described below. The disclosed high-performance, energy-saving, automatic cooper-melting apparatus comprises peripherals 1 that contain a tank 101 acting as a main body. The tank 101 has a bottom peripherally installed with a foundation 102 whose bottom is provided with supports 103.

For better stirring cooper blocks fed thereinto, the disclosed apparatus is equipped with stirrers. Specifically, the tank 101 has a top capped by an upper stirring device 2. The upper stirring device 2 has a top provided with a lid 201 for sealing the apparatus. A sealing pad 202 is attached to the lid 201 from below for preventing leakage. The sealing pad 202 is centrally installed with a driver, or a stirring motor 203. The stirring motor 203 is centrally installed with a shaft, or a post 204. The post 204 is equipped peripherally with stirring rollers 205. The stirring rollers 205 directly realizes even stirring on the copper flakes contained in the tank.

The disclosed apparatus is connected to an external advanced copper-ion detecting device. By controlling the rotation speed of an air suspension blower 5, the intake temperature at an air pipe 8 can be changed, which in turn alters the gas-liquid mixing rate in the apparatus. This allows real-time control of the reaction rate in the apparatus for good balance of the resulting reaction. To ensure accurate detection, the tank 101 has an upper part containing a probe 3. The probe 3 has one end fixed with an electric cord 4. The electric cord 4 has one end connected to the air suspension blower 5. The air suspension blower 5 may use fan blades to agitate air and heats the air to a temperature ranging between 90° C. and 140° C., which is required by the desired chemical reaction. The electric cord 4 has an opposite end connected to a DCS detecting device 6 for endpoint detection.

In order to improve gas-liquid mixing efficiency, the tank 101 has a middle part containing therein a screen plate 7. When pushed out the screen plate 7, the liquid foams and allows more oxygen to dissolve therein. The apparatus has two ends thereof acting as main ports for feeding. The tank 101 has one lateral provided with the air pipe 8, for supplying the action with an adequate amount of oxygen and heat. The tank 101 has an opposite lateral provided with a liquid pipe 9, for supplying the action with an adequate amount of water. For further improving gas-liquid mixing, the air pipe 8 has one end fixed with an air pipe stirrer 10, and the liquid pipe 9 has one end fixed with a liquid pipe stirrer 11. The air pipe stirrer 10 and the liquid pipe stirrer 11 are contained in the tank 101 and near the bottom of the tank 101.

The liquid pipe stirrer 11 has an inlet installed with a 304 stainless-steel section 1101. The 304 stainless-steel section 1101 has one end provided with an adaptor 1102. The adaptor 1102 has an end opposite to the 304 stainless-steel section 1101 connected to a 316L tube 1103, which prevents corrosion. To separate movable parts from immovable parts, the 316L tube 1103 has one end provided with a bearing 1104. The bearing 1104 is stored and sealed inside a storage, or a spherical drum 1105 by a sealing pad. For making the stirrer capable of stirring, the spherical drum 1105 has a bottom peripherally installed with a plurality of stirring rods 1106. The stirring rods 1106 are connected distally by a fixed retaining device, or a ring 1108. The stirring rods 1106 and the ring 1108 are each provided at a surface thereof with a plurality of holes 1107. Between the holes, gas-liquid opposite ejection happens to well mix the air and the liquid. The spherical drum 1105 has one end opposite to the adaptor 1102 provided with a coupling 1109 by means of welding. The coupling 1109 has one end opposite to the spherical drum 1105 installed with a mixing motor 12.

The liquid pipe 9 has an opposite end connected to a flushing pump 13. The tank 101 contains therein a discharging pump 14 near the top of the tank 101. The tank 101 is further provided at the bottom a feeding pump 15.

The 304 stainless-steel section 1101 has an outer surface covered by a sponge insulation layer. The screen plate 7 is formed with dense and evenly arranged meshes, each having a diameter of 1 mm.

The air pipe 8 and the liquid pipe 9 are provided with identical stirrers. In other words, the air pipe stirrer 10 and the liquid pipe stirrer 11 are structurally and dimensionally the same. The air pipe stirrer 10 and the liquid pipe stirrer 11 are separated from each other by an impacting interval of 10 cm.

Working Principles:

The peripherals 1 contain a tank 101 acting as a main body. The tank 101 has a bottom peripherally installed with a foundation 102 whose bottom is provided with supports 103.

For better stirring cooper blocks fed thereinto, the disclosed apparatus is equipped with stirrers. Specifically, the tank 101 has a top capped by an upper stirring device 2. The upper stirring device 2 has a top provided with a lid 201 for sealing the apparatus. A sealing pad 202 is attached to the lid 201 from below for preventing leakage. The sealing pad 202 is centrally installed with a driver, or a stirring motor 203. The stirring motor 203 is centrally installed with a shaft, or a post 204. The post 204 is equipped peripherally with stirring rollers 205. The stirring rollers 205 directly realizes even stirring on the copper flakes contained in the tank.

The disclosed apparatus is connected to an external advanced copper-ion detecting device. By controlling the rotation speed of an air suspension blower 5, the intake temperature at an air pipe 8 can be changed, which in turn alters the gas-liquid mixing rate in the apparatus. This allows real-time control of the reaction rate in the apparatus for good balance of the resulting reaction. To ensure accurate detection, the tank 101 has an upper part containing a probe 3. The probe 3 has one end fixed with an electric cord 4. The electric cord 4 has one end connected to the air suspension blower 5. The air suspension blower 5 may use fan blades to agitate air and heats the air to a temperature ranging between 90° C. and 140° C., which is required by the desired chemical reaction. The electric cord 4 has an opposite end connected to a DCS detecting device 6 for endpoint detection.

In order to improve gas-liquid mixing efficiency, the tank 101 has a middle part containing therein a screen plate 7. When pushed out the screen plate 7, the liquid foams and allows more oxygen to dissolve therein. The apparatus has two ends thereof acting as main ports for feeding. The tank 101 has one lateral provided with the air pipe 8, for supplying the action with an adequate amount of oxygen and heat. The tank 101 has an opposite lateral provided with a liquid pipe 9, for supplying the action with an adequate amount of water. For further improving gas-liquid mixing, the air pipe 8 has one end fixed with an air pipe stirrer 10, and the liquid pipe 9 has one end fixed with a liquid pipe stirrer 11. The air pipe stirrer 10 and the liquid pipe stirrer 11 are contained in the tank 101 and near the bottom of the tank 101. The liquid pipe stirrer 11 has an inlet installed with a 304 stainless-steel section 1101. The 304 stainless-steel section 1101 has one end provided with an adaptor 1102. The adaptor 1102 has an end opposite to the 304 stainless-steel section 1101 connected to a 316L tube 1103, which prevents corrosion. To separate movable parts from immovable parts, the 316L tube 1103 has one end provided with a bearing 1104. The bearing 1104 is stored and sealed inside a storage, or a spherical drum 1105 by a sealing pad. For making the stirrer capable of stirring, the spherical drum 1105 has a bottom peripherally installed with a plurality of stirring rods 1106. The stirring rods 1106 are connected distally by a fixed retaining device, or a ring 1108. The stirring rods 1106 and the ring 1108 are each provided at a surface thereof with a plurality of holes 1107. Between the holes, gas-liquid opposite ejection happens to well mix the air and the liquid. The spherical drum 1105 has one end opposite to the adaptor 1102 provided with a coupling 1109 by means of welding. The coupling 1109 has one end opposite to the spherical drum 1105 installed with a mixing motor 12.

The liquid pipe 9 has an opposite end connected to a flushing pump 13. The tank 101 contains therein a discharging pump 14 near the top of the tank 101. The tank 101 is further provided at the bottom a feeding pump 15. The 304 stainless-steel section 1101 has an outer surface covered by a sponge insulation layer. The screen plate 7 is formed with dense and evenly arranged meshes, each having a diameter of 1 mm. The air pipe 8 and the liquid pipe 9 are provided with identical stirrers. In other words, the air pipe stirrer 10 and the liquid pipe stirrer 11 are structurally and dimensionally the same. The air pipe stirrer 10 and the liquid pipe stirrer 11 are separated from each other by an impacting interval of 10 cm.

It is known that copper wire or copper mass can be made into a CuSO₄ solution with the highest speed at a temperature range between 60° C. and 85° C. The disclosed apparatus uses the oxygen-(air-) supplying air suspension blower that rotates with a speed up to 20000 rpm. With the huge amount of frictional heat generated between the blower blades and air, the air can be heated to 90° C.-120° C. The air pipe uses the 304 stainless-steel section covered by the insulation layer to guide the heated air to enter the copper-melting tank through the anti-corrosion 316L tube, thereby satisfying the temperature condition for produce the desired CuSO₄ solution.

The disclosed apparatus uses the advanced on-line copper/acid ion detector to detect data in a real-time manner, and sends the data to the DCS control system. The DCS control system then according to the present range and data analysis to timely adjust the blower in terms frequency, wind intensity and/or on-off, thereby controlling the copper oxidization speed with the air content in the air, so as to control the production speed of cupric sulfate, thereby achieving copper-ion generation and loss balance.

While the present invention has been described with reference to the preferred embodiments, it is understood that as the contents disclosed herein should be readily understood and can be implemented by a person skilled in the art, all equivalent changes, alternations, replacement, or modifications which do not depart from the concept of the present invention should be within the scope of the present invention, which is defined by the appended claims and equivalents thereof

What is claimed is:

1. A high-performance, energy-saving, automatic cooper-melting apparatus, comprising peripherals, the peripherals including a tank acting as a main body, the tank having a bottom peripherally installed with a foundation whose bottom is provided with supports, the tank having a top capped by an upper stirring device, the upper stirring device having a top being equipped with a lid, the lid having a lower surface with a sealing pad attached thereto, the sealing pad being centrally installed with a stirring motor, the stirring motor being centrally installed with a post, the post being equipped peripherally with stirring rollers, the tank having an upper part containing a probe, the probe having one end fixed with an electric cord, the electric cord having one end connected to an air suspension blower, the electric cord having an opposite end connected to a DCS detecting device, the tank having a middle part containing therein a screen plate, the tank having one lateral provided with an air pipe, the tank having an opposite lateral provided with a liquid pipe, the air pipe having one end fixed with an air pipe stirrer, the liquid pipe having one end fixed with a liquid pipe stirrer, and the air pipe stirrer and the liquid pipe stirrer being contained in the tank and near the bottom of the tank.

2. The high-performance, energy-saving, automatic cooper-melting apparatus of claim 1, wherein the liquid pipe has an opposite end connected to a flushing pump, and the tank contains therein a discharging pump near the top of the tank, while the tank is provided at the bottom a feeding pump.

3. The high-performance, energy-saving, automatic cooper-melting apparatus of claim 1, wherein the liquid pipe stirrer has an inlet installed with a 304 stainless-steel section, the 304 stainless-steel section having one end provided with an adaptor, the adaptor having an end opposite to the 304 stainless-steel section connected to a 316L tube, the 316L tube having one end provided with a bearing, the bearing being sealed in a spherical drum by a sealing pad, the spherical drum having a bottom peripherally installed with a plurality of stirring rods, the stirring rods being connected distally by a ring, the stirring rods and the ring each being provided at a surface thereof with a plurality of holes, the spherical drum having one end opposite to the adaptor provided with a coupling by means of welding, and the coupling having one end opposite to the spherical drum installed with a mixing motor.

4. The high-performance, energy-saving, automatic cooper-melting apparatus of claim 1, wherein the 304 stainless-steel section has an outer surface covered by a sponge insulation layer, and the screen plate is formed with dense and evenly arranged meshes, each having a diameter of 1 mm.

5. The high-performance, energy-saving, automatic cooper-melting apparatus of claim 1, wherein the air pipe and the liquid pipe are provided with identical stirrers, or, the air pipe stirrer and the liquid pipe stirrer are structurally and dimensionally the same, and the air pipe stirrer and the liquid pipe stirrer are separated from each other by an impacting interval of 10 cm.
